(19) United States
(12) Patent Application Publication
(10) Pub. No.: US 2011/0292397 A1
(43) Pub. Date: Dec. 1, 2011

(54) BEAM SCANNING SYSTEM FOR SENSING BIOLOGICAL SUBSTANCES

(76) Inventors: Jae Hun KIM, Seoul (KR); Seok LEE, Seoul (KR); Deok Ha WOO, Seoul (KR); Young Tae BYUN, Guri-si (KR); Sun Ho KIM, Seoul (KR); Young Min JHON, Seoul (KR); Chi Woong JANG, Yongin-si (KR); Shin Geun KIM, Seoul (KR)

(21) Appl. No.: 12/896,773

(22) Filed: Oct. 1, 2010

(30) Foreign Application Priority Data
May 26, 2010 (KR) 10-2010-0049185

(51) Int. Cl. G01B 9/02

(52) U.S. Cl. 356/477

(57) ABSTRACT

Embodiments of adaptively performing clutter filtering are disclosed. In one embodiment, a beam scanning system includes a light source configured to generate a supercontinuum light beam; an optical device configured to receive the supercontinuum light beam for guidance thereof to at least two output ports; and a power supply unit configured to supply voltage to one output port of the at least two output ports to change a phase of the light beam from said one output port.

### CROSS-REFERENCE TO RELATED APPLICATIONS

The present application claims priority from Korean Patent Application No. 10-2010-0049185 filed on May 26, 2010, the entire subject matter of which is incorporated herein by reference.

### TECHNICAL FIELD

The present disclosure generally relates to a beam scanning system, and more particularly to a beam scanning system using an optical phased array for sensing biological substances, such as a cancer cell, a microorganism and the like, in a microfluidic pipe.

### BACKGROUND

Beam scanning system using a laser light source have been extensively used in various fields, such as laser radars, large area scanning displays, free space optical communications, laser printers, barcode readers and the like. Various types of beam scanning systems have been developed, for example, mechanical beam scanning systems, microelectromechanical systems (MEMs) based beam scanning systems, beam scanning systems using an optical phased array, and the like.

Mechanical beam scanning systems generally use a polygon mirror or a holographic disk, so that excellent performance may be exhibited in terms of light utilization efficiency and scanning range. However, mechanical beam scanning systems may require a highly precise optical device for higher accuracy and the structure of these systems may be complex and expensive. Further, since mechanical beam scanning systems operate mechanically, the scanning speed may be limited to a range of milliseconds.

MEMs based beam scanning systems may also operate mechanically in the same manner as mechanical beam scanning systems, so that scanning speed may be limited. In order to resolve the problem of a low scanning speed, research using a lithium niobate electrooptic prism deflector has been carried out. When a lithium niobate electrooptic prism deflector is used in MEMs based beam scanning systems, a relatively high scanning speed of a range of nanoseconds may be achieved. However, a lithium niobate electrooptic prism deflector may require a high driving voltage of over 500V, which may not be practical.

Recently, research for beam scanning systems using an optical phased array has been carried out to overcome the above problems. There is a need for a beam scanning system using an optical phased array that requires low driving voltage and has a high scanning speed.

### SUMMARY

Embodiments for sensing biological substances, such as a cancer cell, a microorganism and the like, in a microfluidic pipe through beam scanning using an optical phased array are disclosed herein. In one embodiment, by way of non-limiting example, a beam scanning system includes a light source configured to generate a supercontinuum light beam; an optical device configured to receive the supercontinuum light beam for guidance thereof to at least two output ports; and a power supply unit configured to supply voltage to one output port of the at least two output ports to change a phase of the light beam from said one output port.

This Summary is provided to introduce a selection of concepts in a simplified form that are further described below in the Detailed Description. This Summary is not intended to identify key or essential features of the claimed subject matter, nor is it intended to be used in determining the scope of the claimed subject matter.

### BRIEF DESCRIPTION OF THE DRAWINGS

FIG. 1 is a schematic diagram showing beam scanning using an optical phased array.

FIG. 2 is a schematic diagram showing an illustrative embodiment of a beam scanning system.

FIG. 3 is a schematic diagram showing an illustrative embodiment of an optical device.

### DETAILED DESCRIPTION

A detailed description may be provided with reference to the accompanying drawings. One of ordinary skill in the art may realize that the following description is illustrative only and is not in any way limiting. Other embodiments of the present invention may readily suggest themselves to such skilled persons having the benefit of this disclosure.

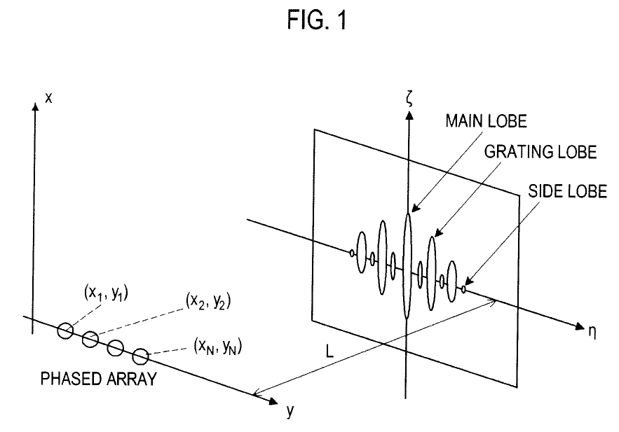

FIG. 1 is a schematic diagram showing beam scanning using an optical phased array. As shown in FIG. 1, when beams are projected from light sources of a phased array on the x-y plane into the ξ-η plane, an interference pattern may appear on the ξ-η plane. This appearance of the interference pattern may be accounted for by the following equation.

$$I ( ξ , η ) = {\vert {\sum }_{n = 1}^{N} {A}_{n} exp ( j {φ}_{n} ) exp [ - j \frac{2 π}{λ L} ( {x}_{n} ξ + {y}_{n} η ) ] \vert}^{2} \times exp [ - \frac{1}{2} {( \frac{2 π {ω}_{0}}{λ L} )}^{2} ( {ξ}^{2} + {η}^{2} ) ] \qquad ( 1 )$$

where Aₙ represents a light beam intensity emitted from an n^{th} light source, φₙ represents a phase of the light beam emitted from the n^{th} light source, ω₀ represents a spot size of the light beam, λ represents a wavelength of the light beam, L represents a distance between the x-y plane and the ξ-η plane, and xₙ and yₙ represent a location of the n^{th} light sources on the x-y plane.

As shown in equation (1), if a phase of a light beam emitted from the light source is changed, a location of the interference pattern may also be changed on the ξ-η plane. Thus, beam scanning may be performed by changing the location of the interference pattern in one embodiment.

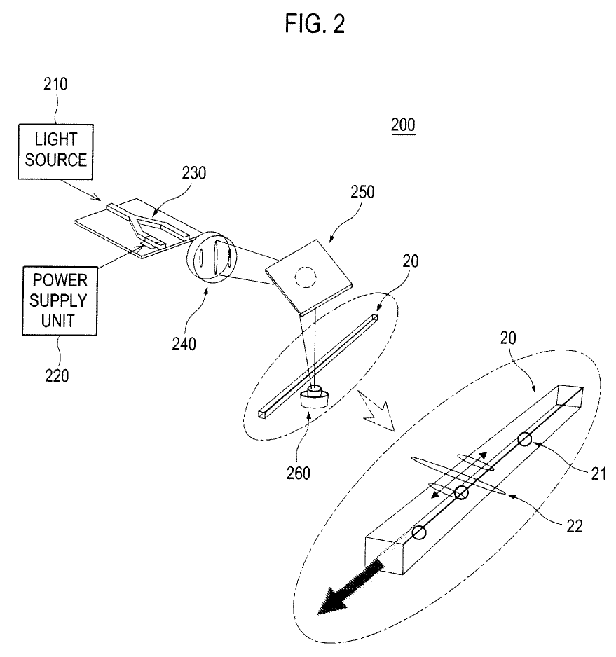

FIG. 2 is a schematic diagram showing an illustrative embodiment of a beam scanning system. Referring to FIG. 2, the beam scanning system 200 may include a light source 210, a power supply unit 220, an optical device 230, a beam focusing unit 240, a mirror 250 and a beam processing unit 260. The beam scanning system 200 may further include a storage unit (not shown) for storing information related to a plurality of biological substances (“biological substance related information”). The biological substance related information may include spectrum data and images, and the like, that are associated with the biological substances.

The light source 210 may be configured to generate a light beam. In one embodiment, the light source may include a supercontinuum light source. Any type of light sources capable of generating a supercontinuum light beam may be used as the light source 210.

The power supply unit 220 may be configured to supply regulated voltages. The voltage may be supplied to the optical device 230. In one embodiment, any type of electric device capable of supplying regulated voltages may be used as the power supply unit 220.

The optical device 230 may receive the light beam emitted from the light source 210 for guidance thereof in at least two paths. The optical device 230 may be configured to change a phase of the light beam, which passes through one of the paths, responsive to the voltage supplied from the power supply unit 220. Therefore, a location of an interference pattern of the light beam, which is a far-field pattern of the light beam, may be adjusted.

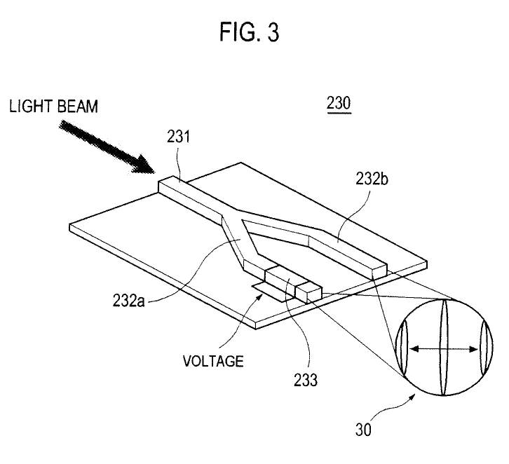

FIG. 3 is a schematic diagram showing an illustrative embodiment of the optical device 230. Referring to FIG. 3, the optical device 230 may include a Y-branch type of optical device. The optical device 230 may include an input port 231 and two output ports 232a and 232b. The input port 231 may receive the light beam emitted from the light source 210. The output port 232a and 232b may branch off from the input port 231. The optical device 230 may further include an electrode 233 that may be mounted on one of the output ports 232a and 232b (e.g., output port 232a). The voltage may be applied to the electrode 233 such that an electric field is generated. Thus, a phase of the light beam, which is guided by the corresponding output port, e.g., the output port 232a, may be changed in response to the electric field.

Although the foregoing embodiment has described that the optical device 230 has two output ports 232a and 232b, the number of the output ports may not be limited thereto. For example, the optical device 230 may include more than two output ports. Also, the electrode 233 may be mounted on the output port 232a in one embodiment. However, it should be noted herein that the way the electrode 233 is mounted may not be limited thereto. For example, the electrode 233 may be mounted on the output port 232b.

In FIG. 3, reference numeral “30” represents the interference pattern, which is a far-field pattern of the light beams outputted from the output ports 232a and 232b. When voltage is applied to the electrode 233, a carrier density of the light beam, which is guided by a waveguide, i.e., the output port 232a, may vary and a refractive index of the light beam may also vary in response to the change of the carrier density. Thus, the phase of the light beam guided by the output port 232a may be changed, so that a phase difference between the light beams outputted from the output ports 232a and 232b may be caused. If the phase of the supercontinuum light beam is changed as explained above, the position of the interference pattern may also be changed, as shown in equation (1).

In one embodiment, the location of the interference pattern has been adjusted by using the electric field generated by applying the voltage to the electrode 233. However, the adjustment of location of the interference pattern may not be limited thereto. In another embodiment, an optical field or a microwave may be used to change the phase of the light beam, which may be guided by the optical device, for location adjustment of the interference pattern.

Referring back to FIG. 2, the beam focusing unit 240 may be configured to focus the light beams outputted from the optical device 230. The beam focusing unit 240 may be any devices capable of focusing the light beams, such as a focusing lens.

The mirror 250 may reflect the light beams, which may be focused in the beam focusing unit 240, to traverse across a target 20, such as a microfluidic pipe. The microfluidic pipe 20 may be a pipe in which the biological substances 21 including a cancer cell, a microscopic organism and the like may flow.

The beam processing unit 260 may be configured to sense the biological substances 21 flowing in the microfluidic pipe 20 based on the light beams, which have traversed across the microfluidic pipe 20. Specially, the beam processing unit 260 may receive the light beams 22 that have traversed across the microfluidic pipe 20 and form biological information on the biological substance based thereon. In one embodiment, the biological information may include spectrum data and images of the biological substances. The beam processing unit 260 may retrieve the biological substance related information from the storage unit and compare the biological information with the retrieved biological substance related information. The beam processing unit 260 may form identity information of the biological substance according to the comparison result. The identity information may be outputted through an output device (not shown). The output device may include a display unit, a printer and the like. Also, the output device may be a storage unit.

In one embodiment, the beam processing unit 260 may include a light sensor array (not shown) in which a plurality of light sensors for sensing different wavelength bands may be arrayed. In another embodiment, the beam processing unit 260 may include a wide-band light sensor array, in which a plurality light sensors may be included. In one embodiment, each of the light sensors may have a different wavelength filter. The light sensor may include a charge-coupled device for imaging and a spectrometer for spectroscopy. Each of the light sensors may output a sensing signal in response to the received light beam. The beam processing unit 260 may successively form an image of the biological substance and sense a spectroscopic peak by combining the sensing signals outputted from the light sensor array. Thus, an in-situ analysis of the biological substances in the microfluidic pipe may be achieved according to one embodiment.

In the above embodiment, it has been described that the mirror is employed for reflecting the focused light beams to the microfluidic pipe 20. However, in another embodiment, the focused light beams may be directly projected to the microfluidic pipe 20.

Although embodiments have been described with reference to a number of illustrative embodiments thereof, it should be understood that numerous other modifications and embodiments can be devised by those skilled in the art that will fall within the scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A beam scanning system, comprising:
a light source configured to generate a supercontinuum light beam;
an optical device configured to receive the supercontinuum light beam for guidance thereof to at least two output ports; and
a power supply unit configured to supply voltage to one output port of said at least two output ports to change a phase of the light beam from said one output port.

2. The beam scanning system of claim 1, wherein the optical device comprises an input port configured to receive the supercontinuum light beam, and wherein the at least two output ports are configured to branch off from the input port to output the light beam, and the optical device comprises an electrode mounted on said one output port and configured to generate an electric filed responsive to the voltage supplied thereto.

3. The beam scanning system of claim 2, wherein the optical device further comprises a Y-branch type of optical device.

4. The beam scanning system of claim 1, further comprising:
a storage unit to store biological substance related information;
a beam focusing unit configured to focus the light beams outputted from the optical device;
a mirror configured to reflect the focused beams to traverse across a microfluidic pipe in which a biological substance is allowed to flow; and
a beam processing unit configured to receive the light beams that traversed across the microfluidic pipe, said beam processing unit being further configured to form biological information on the biological substance based on the received beams, retrieve the biological substance related information from the storage unit for comparison with the biological information and form identity information of the biological substance flowing in the microfluidic pipe according to the comparison.

5. The beam scanning system of claim 4, wherein the biological information comprises any one of spectrum data and beam image of the biological substance.

6. The beam scanning system of claim 4, wherein the beam processing unit comprises a light sensor array having a plurality of light sensors each for sensing a different wavelength.

7. The beam scanning system of claim 4, wherein the beam processing unit comprises a light sensor array having a plurality of light sensors each having a different wavelength filter.
